(19) United States
(12) Patent Application Publication
(10) Pub. No.: US 2015/0085209 A1
(43) Pub. Date: Mar. 26, 2015

(54) TOUCH DISPLAY DEVICE

(71) Applicants: Interface Optoelectronics (Shenzhen) Co., Ltd., Shenzhen City (CN); GENERAL INTERFACE SOLUTION LIMITED, MIAOLI COUNTY (TW)

(72) Inventors: Cheng-Ta Huang, Taoyuan County (TW); Tsung-Chen Chou, Taoyuan County (TW)

(21) Appl. No.: 14/555,675

(22) Filed: Nov. 27, 2014

(30) Foreign Application Priority Data
Nov. 20, 2014 (CN) 201410668395.2

(51) Int. Cl. G02F 1/1333; G06F 3/041

(52) U.S. Cl. CPC G02F 1/13338; G02F 1/133305; G06F 3/0412
USPC 349/12

(57) ABSTRACT

A touch display device includes an LCD panel, a flexible sensor film disposed on the LCD panel, a cover lens disposed on the flexible sensor film, a first adhesive layer between the flexible sensor film and the LCD panel, a second adhesive layer between the flexible sensor film and the cover lens, and a system mechanism part enclosing the above-described components.

### BACKGROUND OF THE INVENTION

1. Field of the Invention

The present invention relates to a touch display device. More particularly, the present invention relates to a touch display device utilizing a flexible sensor film to achieve narrow border or borderless appearance of the touch display device.

2. Description of the Prior Art

FIG. 1 illustrates the conventional touch display device. As shown in FIG. 1, a conventional touch display device 1 generally includes an liquid crystal display (LCD) module 10, a touch panel module 12 stacked on the LCD module 10, a protective cover 14 stacked on the touch panel module 12, and a system mechanism part 16 enclosing the above components. The touch panel module 12 is fixed to the LCD module 10 through the adhesive layer 121. The protective cover 14 is fixed to the touch panel module 12 through the adhesive layer 122.

The above-described touch display device still has several shortcomings. For example, the size of touch panel module 12 is often greater than the LCD module 10, while the size of the frame 102 of the LCD module 10 and the system mechanism part 16 is greater than touch panel module 12, resulting in a bulky appearance. In addition, the ink layer 142 of the protective cover 14 is required to consider the metal frame 102 of the LCD module 10 and peripheral traces of the touch panel module 12. Therefore, the prior art touch display device 1 cannot achieve the narrow border appearance. Furthermore, the size of the mask for the manufacture of the sensor layer of the touch panel module 12 is only applicable to a single panel type, and cannot be shared.

### SUMMARY OF THE INVENTION

Therefore, a primary object of the present invention is to provide an improved structure of the touch display device, which has a flexible sensor layer, and can achieve a narrow border or borderless appearance.

According to one embodiment of the invention, a touch display device includes a liquid crystal display (LCD) panel, a flexible sensor layer disposed on the LCD panel, a cover lens disposed on the flexible sensor layer, a first adhesive layer disposed between the flexible sensor layer and the LCD panel, a second adhesive layer disposed between the flexible sensor layer and the cover lens, and a system mechanism part enclosing at least the LCD panel, the flexible sensor layer, the first adhesive layer, and the second adhesive layer.

According to one embodiment of the invention, the LCD panel is an open-cell LCD panel. The touch display device further comprising a backlight unit disposed under the open-cell LCD panel.

According to one embodiment of the invention, the system mechanism part is coupled to the cover lens and a lower part to thereby enclose at least the LCD panel, the flexible sensor layer, the first adhesive layer, and the second adhesive layer.

According to one embodiment of the invention, the flexible sensor layer comprises a peripheral region and edge traces in the peripheral region. The peripheral region is bent to a position that is in close proximity to a sidewall of the LCD panel. The peripheral region is bent such that the peripheral region is perpendicular to a top surface of the LCD panel. The peripheral region is adhered to an interior surface of the system mechanism part through the second adhesive layer.

According to one embodiment of the invention, no ink layer is disposed along a lower perimeter of the cover lens.

According to one embodiment of the invention, the system mechanism part is composed of plastic, metal, glass, or a composite material.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the conventional touch display device.

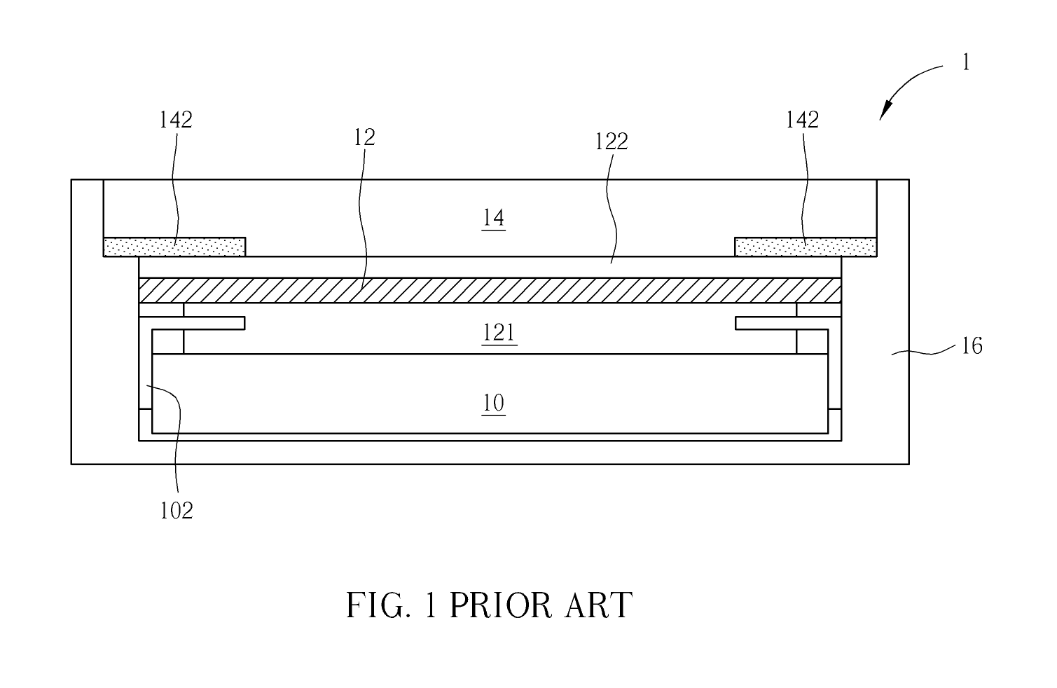

FIG. 2 is a schematic, cross-sectional diagram showing a touch display device according to one embodiment of the invention.

FIG. 3 is a schematic, cross-sectional diagram showing a touch display device according to another embodiment of the invention.

FIG. 4 is a schematic, cross-sectional diagram showing a touch display device according to still another embodiment of the invention.

### DETAILED DESCRIPTION

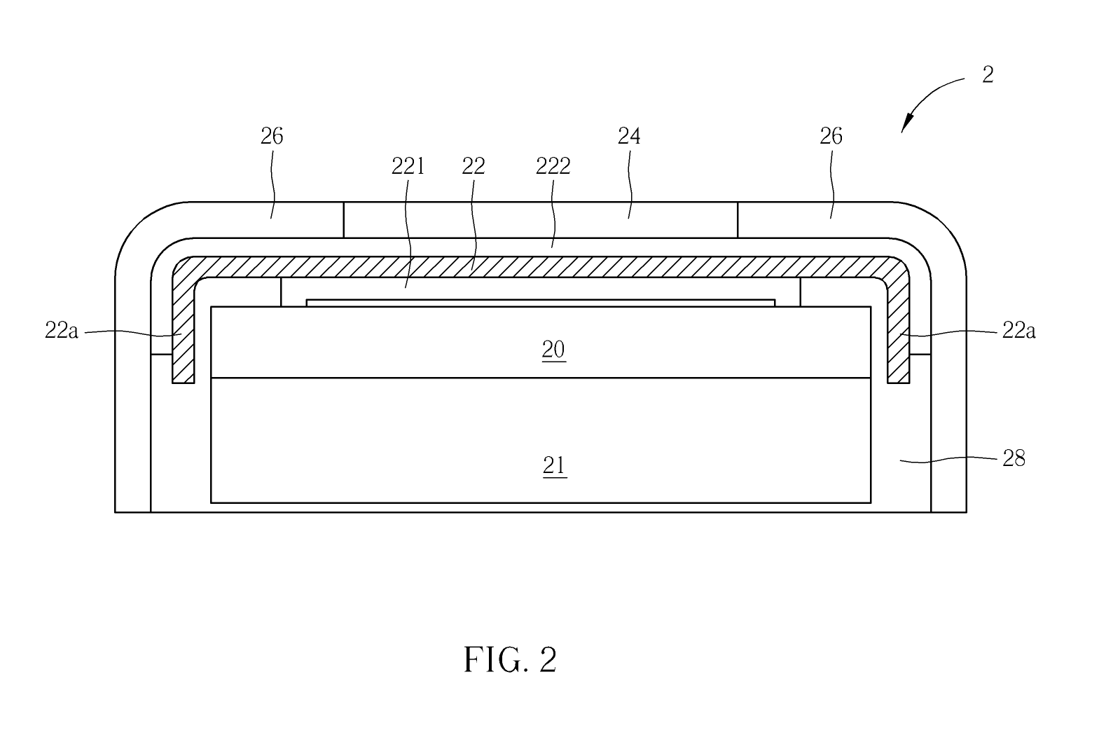

FIG. 2 is a schematic, cross-sectional diagram showing a touch display device according to one embodiment of the invention. As shown in FIG. 2, the touch display device 2 of the invention may comprise an open-cell liquid crystal display (LCD) panel 20, a backlight unit (BLU) 21 disposed under the open-cell LCD panel 20, a flexible sensor film 22 disposed above the open-cell LCD panel 20, a cover lens 24 disposed on the flexible sensor film 22, a first adhesive layer 221 disposed between the flexible sensor film 22 and the open-cell LCD panel 20, a second adhesive layer 222 disposed between the flexible sensor film 22 and the cover lens 24, and a system mechanism part 26 coupled to the cover lens 24. The system mechanism part 26 and a lower part 28 together enclose the above-described components.

According to one embodiment of the invention, the flexible sensor film 22 comprises a peripheral region 22a. Edge traces (not shown) may be disposed within the peripheral region 22a. According to one embodiment of the invention, the peripheral region 22a is a bent portion of the flexible sensor film 22, which is disposed in close proximity to the sidewalls of the open-cell LCD panel 20. According to one embodiment of the invention, the peripheral region 22a may be bent to a vertical position such that the peripheral region 22a is substantially perpendicular to the top surface of the open-cell LCD panel 20. However, the invention is not limited to such angle configuration. According to one embodiment of the invention, the peripheral region 22a may be adhered to the interior surface of the system mechanism part 26 through the second adhesive layer 222.

According to one embodiment of the invention, because the peripheral region 22a is bent to a position that is in close proximity to the sidewalls of the open-cell LCD panel 20, an ink layer can be skipped or omitted from the lower peripheral surface of the cover lens 24, to thereby achieving an inkless design. One advantage of the inkless design is that the spared ink screen printing process can simplify the manufacture steps, reduce the materials used, and thereby reducing production cost. Further, the problem of uncured adhesive under shadow can be solved, thereby improving the yield. In addition, the inkless design makes the size of visible area (VA) about the size of the cover lens 24.

According to one embodiment of the invention, the stack structure of the above-described touch display device 2 is fully compatible with current Advanced Direct Bonding (ADB) processes. Therefore, the manufacture process is simplified and the production cost can be reduced. Because the flexible sensor layer 22 is incorporated, it is possible to support a panel down to a certain size. It is advantageous to use the present invention because of the high compatibility and the low cost of the mask.

According to one embodiment of the invention, the stack structure of the above-described touch display device 2 can reduce the overall thickness and can achieve further thickness reduction demand.

According to one embodiment of the invention, depending upon the design requirements and the demand of the function and appearance of the device, the system mechanism part 26 may be composed of plastic, metal, glass, or composite materials, but not limited thereto. For example, the system mechanism part 26 may be composed of polycarbonate (PC), which can constitute integrated fully flat plane appearance with the cover lens by using insert molding processes.

According to embodiments of the invention, the system mechanism part 26 may be integrated by upper frame integration system or hinge-up to achieve the effect of the fully flat plane.

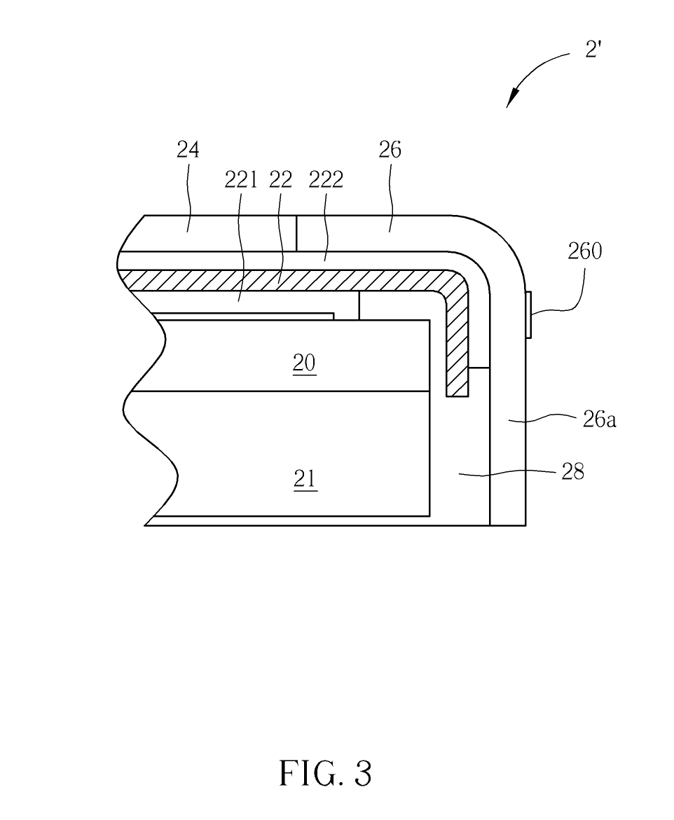

FIG. 3 is a schematic, cross-sectional diagram showing a touch display device according to another embodiment of the invention. As shown in FIG. 3, the components of the touch display device 2′ according to another embodiment are similar to that depicted in FIG. 2. The difference is that, as shown in FIG. 3, a side bottom 260 is disposed on the sidewall 26a of the system mechanism part 26 of the touch display device 2′. According to another embodiment, the side bottom 260 corresponds to the peripheral region 22a that is bent to a position in close proximity to the sidewalls of the open-cell LCD panel 20. According to another embodiment, the side button 260 may be a touch function key or a physical button, but not limited thereto.

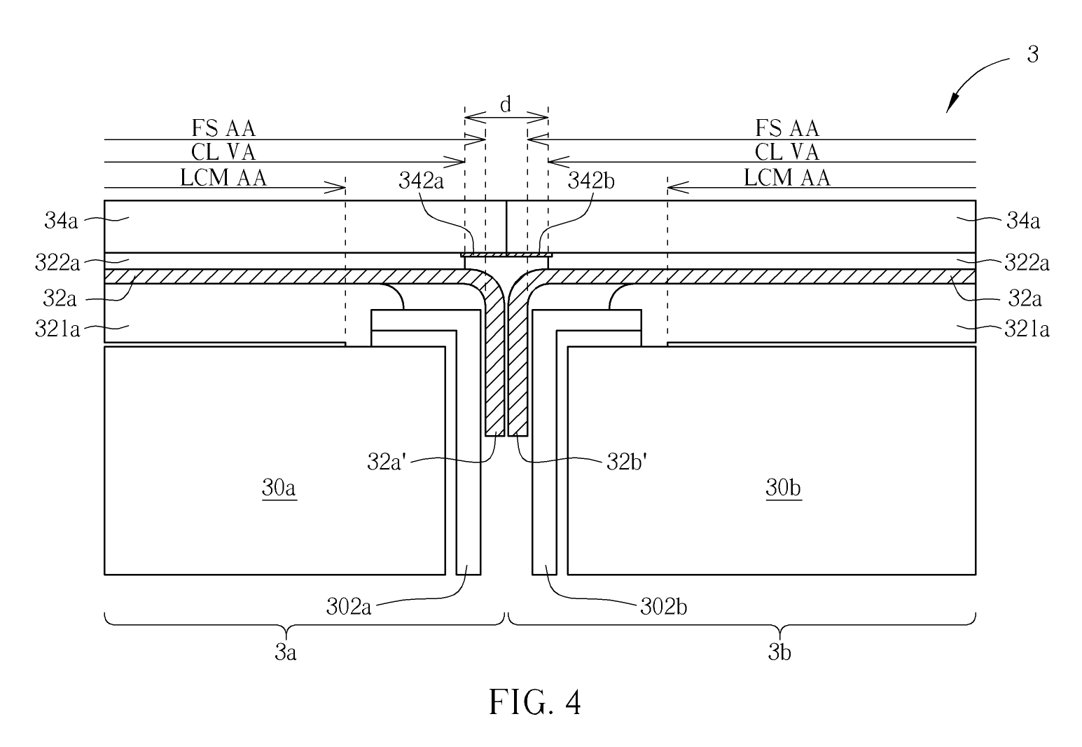

FIG. 4 is a schematic, cross-sectional diagram showing a touch display device according to still another embodiment of the invention, wherein an exemplary stitched capacitor-type touch display device 3 with a narrow border design due to the use of the flexible sensor layer is shown. As shown in FIG. 4, the stitched capacitor-type touch display device 3 comprises at least a first touch display device 3a and a second touch display device 3b disposed in close proximity to the first touch display device 3a. For the sake of simplicity, the system mechanism parts or casings are omitted in the figure.

The first touch display device 3a may comprise an LCD module 30a, a flexible sensor film 32a disposed above the LCD module 30a, a cover lens 34a disposed on the flexible sensor film 32a, an adhesive layer 321a disposed between the flexible sensor film 32a and the LCD module 30a, and an adhesive layer 322a disposed between the flexible sensor film 32a and the cover lens 34a.

The second touch display device 3b may comprise an LCD module 30b, a flexible sensor film 32b disposed above the LCD module 30b, a cover lens 34b disposed on the flexible sensor film 32b, an adhesive layer 321b disposed between the flexible sensor film 32b and the LCD module 30b, and an adhesive layer 322b disposed between the flexible sensor film 32b and the cover lens 34b.

The peripheral region 32a′ of the flexible sensor film 32a and the peripheral region 32b′ of the flexible sensor film 32b are bent to a position that is in close proximity to the sidewalls of the LCD module 30a and the LCD module 30b. More specifically, the peripheral region 32a′ and the peripheral region 32b′ are bent to the gap between the metal frame 302a of the LCD module 30a and the metal frame 302b of the LCD module 30b. Therefore, the width of the ink layer 342a disposed along the lower perimeter of the cover lens 34a and the width of the ink layer 342b disposed along the lower perimeter of the cover lens 34b can be minimized. As shown in FIG. 4, the combined capacitor-type touch display device 3 has a frame width d that is equal to the combination of the widths of the ink layer 342a and the ink layer 342b.

FIG. 4 also demonstrates the comparison between the visible area and the active areas. The visible areas of the cover lens 34a and the cover lens 34b are denoted as “CL VA”, the active areas of the flexible sensor film 32a and the flexible sensor film 32b are denoted as “FS AA”, while the active areas of the LCD module 30a and the LCD module 30b are denoted as “LCM AA”. According to the embodiment of the invention, the dimension of FS AA of the flexible sensor film 32a and the flexible sensor film 32b is greater than the dimension of CL VA of the cover lens 34a and the cover lens 34b. The dimension of CL VA of the cover lens 34a and the cover lens 34b is greater than the dimension of LCM AA of the LCD module 30a and the LCD module 30b.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
a liquid crystal display (LCD) panel;
a flexible sensor layer disposed on the LCD panel;
a cover lens disposed on the flexible sensor layer;
a first adhesive layer disposed between the flexible sensor layer and the LCD panel;
a second adhesive layer disposed between the flexible sensor layer and the cover lens; and
a system mechanism part enclosing at least the LCD panel, the flexible sensor layer, the first adhesive layer, and the second adhesive layer.

2. The touch display device according to claim 1, wherein the LCD panel is an open-cell LCD panel.

3. The touch display device according to claim 2 further comprising a backlight unit disposed under the open-cell LCD panel.

4. The touch display device according to claim 1, wherein the system mechanism part is coupled to the cover lens and a lower part to thereby enclose at least the LCD panel, the flexible sensor layer, the first adhesive layer, and the second adhesive layer.

5. The touch display device according to claim 1, wherein the flexible sensor layer comprises a peripheral region and edge traces in the peripheral region.

6. The touch display device according to claim 5, wherein the peripheral region is bent to a position that is in close proximity to a sidewall of the LCD panel.

7. The touch display device according to claim 5, wherein the peripheral region is bent such that the peripheral region is perpendicular to a top surface of the LCD panel.

8. The touch display device according to claim 5, wherein the peripheral region is adhered to an interior surface of the system mechanism part through the second adhesive layer.

9. The touch display device according to claim 1, wherein no ink layer is disposed along a lower perimeter of the cover lens.

10. The touch display device according to claim 1, wherein the system mechanism part is composed of plastic, metal, glass, or a composite material.
